(19) United States
(12) Patent Application Publication
(10) Pub. No.: US 2019/0214158 A1
(43) Pub. Date: Jul. 11, 2019

(54) Steam Superheater

(71) Applicant: PUBLIC JOINT STOCK COMPANY “MACHINE-BUILDING PLANT “ZIO-PODOLSK”, Moscow region, Podolsk (RU)

(72) Inventors: Vladimir Borisovich TREN'KIN, Moscow region, Podolsk (RU); Oleg Valerievich SUCHKOV, Moscow region, Podolsk (RU); Vladimir Vladimirovich MARKIN, Moscow region, Podolsk (RU); Valerij Anatol'evich MARTYNOV, Moscow region, Podolsk (RU); Aleksandr Evgen'evich BORDUKOV, Tula region, Novomoskovsk (RU)

(21) Appl. No.: 16/313,728

(22) PCT Filed: Sep. 30, 2016
(86) PCT No.: PCT/RU2016/000648

§ 371 Date: Dec. 27, 2018

(51) Int. Cl. G21D 5/14; F22B 37/26; F22G 3/00

(52) U.S. Cl. CPC G21D 5/14; F22G 3/003; F22G 3/006; F22B 37/26

(57) ABSTRACT

The invention relates to energy, in particular for the system of separation and superheating of steam for nuclear power plant turbines. The invention is aimed at solving the problem of reducing the mass and dimension parameters while maintaining the efficiency of heat exchange.

The task in the claimed invention is solved by the fact that both tube banks of the first and second superheating stages are rotated vertically at the same height in such a way that they form between them and the inside of the housing two segmental inlet headers, a wedged outlet header with an angle of turn from 10° to 90°, and the steam outlet nozzle is located in a vertical case opposite the wedged outlet header. The actual reduction in mass and dimension parameters is 18-25%, which allows using this solution in compact systems for steam separation and superheating.

### CROSS-REFERENCE TO RELATED APPLICATIONS

This application is a US 371 Application from PCT/RU2016/000648 filed Sep. 30, 2016, the technical disclosures of which are hereby incorporated herein by reference.

The invention relates to energy, in particular for the system of separation and superheating of steam for nuclear power plant turbines.

A steam superheater of nuclear power plant turbine is known, which comprises a housing and is located above the separator. The steam superheater comprises bundles of heat exchange tubes, combined in tube banks. Tube banks are installed in the housing parallel to its direct axis and grouped into two blocks of rectangular section (Utility Model Patent of the Russian Federation no. 54271 Sh, IPC N02K7/00, published on 10 Jun. 2006).

A steam superheater is known that is designed to superheat steam for turbine (Utility Model Patent of the Russian Federation no. 88774 Sh, IPC F22B 37/26, published on 20 Nov. 2009), built into the body and consisting of tube banks made in the form of rectangular parallelepipeds. Tube banks are installed parallel to its direct axis.

The closest technical solution chosen for the prototype is a steam superheater included in the steam superheater separator and consisting of a tube bank of the first stage and a tube bank of the first stage in a vertical housing, with the tube banks located one above the other (Patent RU 2522273, published on 10 Jul. 2014)

The drawback of the said design of the steam superheater is in large geometric dimensions in height due to the location of the primary and secondary superheater banks one above the other, which leads to an increase in the weight and dimensions of the equipment, laboriousness and cost of their manufacture, as well as Oversized™ during transportation. In the case of installation of steam superheaters of the first and second stage side by side (in parallel) with each other, the flow area in the terminal header behind the steam superheaters of the first and second stages decreases, which in turn leads to a decrease in the efficiency of heat exchange due to an increase in the hydraulic resistance and unevenness of the flow velocity field.

The invention is aimed at solving the problem of reducing the mass and dimension parameters while maintaining the efficiency of heat exchange.

The task in the claimed invention is solved by the fact that both tube banks of the first and second superheating stages are rotated vertically at the same height in such a way that they form between them and the inside of the housing two segmental inlet headers, a wedged outlet header with an angle of turn from 10° to 90°, and the steam outlet nozzle is located in a vertical case opposite the wedged outlet header.

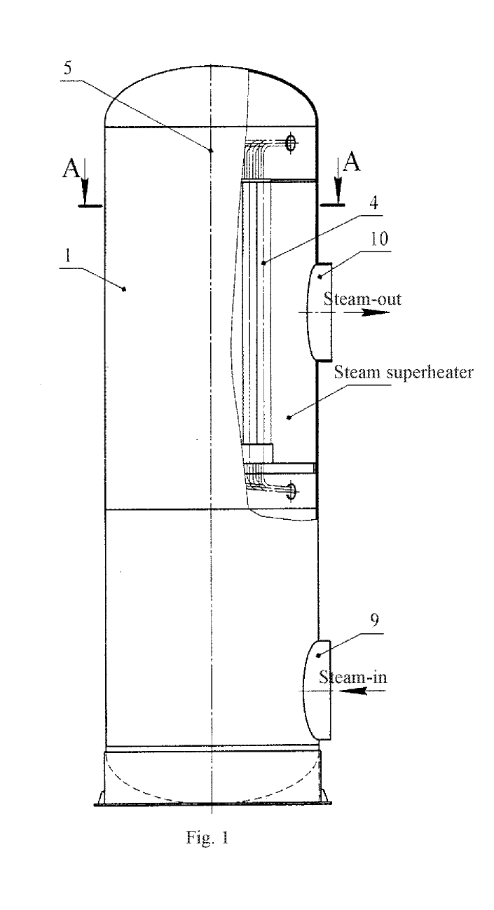

The invention is illustrated in the drawings FIG. 1.2

FIG. 1—Longitudinal cross section of the steam superheater;

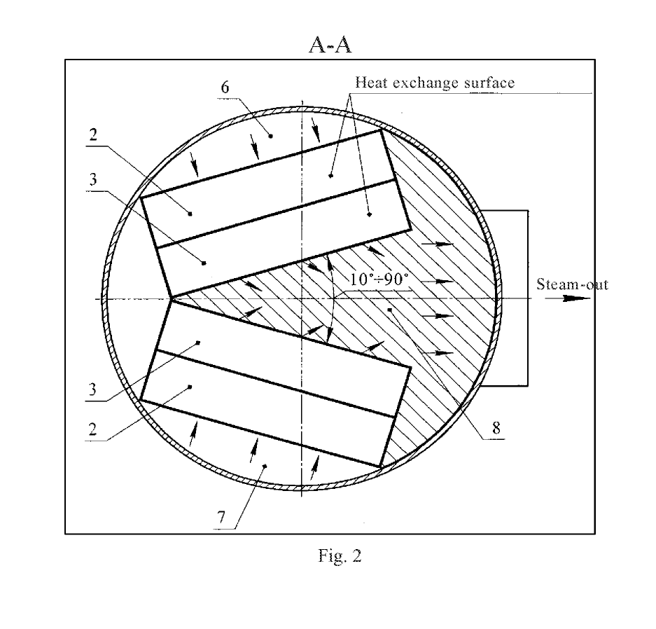

FIG. 2—Section A-A in FIG. 1.

The steam superheater includes a housing 1 in which two banks of heat exchange tubes 2,3 are placed. Heat exchange surfaces 4 of both tube banks are installed side by side in the housing 1 parallel to its direct axis 5. The heat exchange surfaces are divided into two parts and angled relative to each other, forming two segmental inlet headers 6, 7 and a wedged outlet header 8.

The angle between the heat exchange surfaces of the tube banks is from 10° to 90°.

The steam superheater operates as follows.

Wet steam through the inlet nozzle 9 enters the lower part of the steam superheater, from where the steam enters the inlet segmental inlet headers 6, 7 out of which passes through the heat exchange surfaces of the tube banks of the first 2 and second superheating stages 3. In the heat exchange surfaces, the heated steam superheats due to heat that heats the steam passing through the in-tube space of the heat exchange surface. Superheated steam from the superheaters enters the wedged outlet header and exits from the superheater through the nozzle 9.

Due to the fact that the heat exchange surfaces of the steam superheaters are separated and angled relative to each other, two inlet headers 6, 7 and a wedged outlet header 8 are formed, which provide sufficient flow area to ensure efficient heat exchange and low resistance (loss). The result is that the efficiency of the steam superheater compared with the prototype while reducing the dimensions of the housing 1.

In addition, the location of the outlet nozzle 10 on the same level with the outlet header 8 reduces the resistance of the working steam and thus, ensures the efficiency of heat exchange.

Optimisation of the angle between the surfaces of the steam superheater's tube banks in the range from 10° to 90° is due to the combination of the optimal steam flow rate to the heat exchange surface (provided by the steam flow area) and the need to evenly distribute the steam flow at the inlet and outlet of the steam superheater's tube banks while ensuring a compact location to the housing diameter. If the angle is decreased less than 10°, there is an increase in resistance in the outlet header 8 by reducing its flow area. If the angle is increased above 90°, the heat exchange performance will be decreased by reducing the area of the heat exchange surface with a constant diameter of the housing.

These angles were obtained by constructing mathematical models and experimental purging on the stands.

Thus, the technical problem—reducing the mass and dimension parameters without simultaneously reducing the efficiency of heat exchange is achieved—the actual reduction of mass and dimension parameters is 18-25%, which allows using this solution in compact systems for steam separation and superheating.

1. A steam superheater located in the upper part of the vertical housing, including two tube banks of the first and second superheating stages, inlet and outlet headers and nozzles of the steam-in and steam-out, wherein both tube banks of the first and second superheating stages are rotated vertically at the same height in such a way that they form between them and the inside of the housing two segmental inlet headers, a wedged outlet header with an angle of turn from 10° to 90°, and the steam outlet nozzle is located in a vertical case opposite the wedged outlet header.
